(19) United States
(12) Patent Application Publication
(10) Pub. No.: US 2018/0135818 A1
(43) Pub. Date: May 17, 2018

(54) DECORATIVE LIGHT STRING

(71) Applicant: Jiangmen Pengjiang Guangda Electrical Appliances Co,. Ltd., Jiangmen City (CN)

(72) Inventor: Hsiu-tsen CHANG, Jiangmen City (CN)

(21) Appl. No.: 15/350,249

(22) Filed: Nov. 14, 2016

(51) Int. Cl. F21S 4/15; F21V 23/00; F21V 21/008; F21V 23/04

(52) U.S. Cl. CPC F21S 4/15; F21V 23/003; F21W 2121/006; F21V 23/0407; F21V 21/008

(57) ABSTRACT

The invention relates to a decorative light string which comprises a net lamp and an ice bar lamp. The net lamp comprises two or more light strings in side-by-side arrangement, the light strings are interdigitated with each other and are woven into a mesh net lamp, and the ice bar lamp is woven at the bottom of the net lamp. When the net lamp is woven by using the light strings, the ice bar lamp is woven at the bottom of the net lamp. The decorative light string disclosed by the invention can be either hung below an eave or at the upper end of a window or put on grass or a tree. The net lamp and the ice bar lamp are controlled to twinkle in a hierarchical manner by a control box, so the user can experience a new impression.

### FIELD OF THE INVENTION

The invention relates to a decorative light string.

### BACKGROUND OF THE INVENTION

Light string decoration is very popular abroad. In particular, in a festival, for example, Christmas, light strings are wound on the trees and below the eaves, etc., for decoration. In most early decorative lights, a plurality of bulbs are arranged on a same wire at intervals, and one end of the decorative light is plugged into a power supply through the wire, so that the whole light string is energized to produce a decorative effect of lighting or flicker. However, conventional light strings are relatively monotonous in lighting effect due to the linear arrangement of bulbs. Meanwhile, it is troublesome and inconvenient to wind the light strings on Christmas trees and the like or recover the light strings after use.

In recent times, net lamp designs in various structural shapes are developed. The whole decorative light is designed like a net, so that it is convenient to cover the decorative sites (for example, Christmas trees and bushes) with all the integrally-formed bulbs and wires. Besides rapid covering, it is convenient to take down and store the decorative light when it is not being used. Another lamp to be used in festivals is an ice bar lamp which is provided with a transverse main wire for being positioned at the upper edge of the window and the lower edge of the eave. The ice bar lamp is provided with a plurality of pendent light strings of different lengths arranged at intervals successively along the transverse main wire, so that when energized to illuminate, the bulbs on these light strings which are different in length may seem like ice bars clinging to the window face or hung below the eave when it snows. However the net lamp or the ice bar lamp is individually manufactured and marketed at present.

### SUMMARY OF THE INVENTION

In order to solve the technical problems described above, the invention aims to provide a decorative light string combining characteristics of the net lamp and the ice bar lamp.

The technical solution adopted by the invention is as follows.

A decorative light string comprises a net lamp and an ice bar lamp, wherein the net lamp comprises two or more light strings in side-by-side arrangement, the light strings are interdigitated with each other and are woven into a mesh net lamp, and the ice bar lamp is woven at the bottom of the net lamp.

Further, in the net lamp, wires of a lower light string passes through a rear part of a lampholer of an adjacent upper light string and is fixed, so that the net lamp can form a mesh by tensioning.

Further, the net lamp is provided with positioning buckles around both sides of the lampholder, and the wires of the lower light strings are fixed by the positioning buckle when passing through the lampholder of the upper light string.

Further, the ice bar lamp comprises a main lamp line arranged parallel to the light strings and strip lamps hung at intervals below the main lamp line to form the ice bar lamp.

Further, the main lamp line of the ice bar lamp is woven to the bottom of the net lamp.

Further, the lengths of the strip lamps can be set according to required styles of the ice bar lamps, so that the free ends of the strip lamps hung at intervals below the main lamp line form a required style of the ice bar lamp.

Further, the light strings forming the net lamp and the ice bar lamp are respectively connected to a control box, and the control box controls the light strings forming the net lamp and the ice bar lamp to flicker and twinkle in a hierarchical manner in up and down directions.

The invention has the beneficial effects that when the net lamp is woven by using the light strings, the ice bar lamp is woven at the bottom of the net lamp at the same time, so that the decorative light string has the characteristics of the net lamp and the ice bar lamp at the same time so as to obtain a novel and characteristic decorative effect;. The decorative light string disclosed by the invention can be either hung below an eave or at the upper end of a window or put on grass or a tree. The net lamp and the ice bar lamp are controlled to twinkle in a hierarchical manner through a control box, so that a user has a new impression.

### BRIEF DESCRIPTION OF THE DRAWINGS

In order to describe the technical scheme adopted by the embodiments of the invention more clearly, a brief introduction of drawings needed in the description of the embodiments will be made below. It is obvious that the described drawings show only some but not all the embodiments of the invention. A person skilled in the art also can envisage other design schemes and drawings according to the drawings without the exercise of inventive faculty, wherein:

FIG. 1 is a schematic diagram of the decorative light string according to the invention; and

FIG. 2 is a schematic diagram of a woven structure of a net lamp at a lampholder, according to the invention.

### DETAILED DESCRIPTION OF THE EMBODIMENTS

Objects, features and effects of the invention will be sufficiently understood from the following detailed and full description of the conception, specific structure and generated technical effects of the invention taken in conjunction with embodiments and the drawings. It is obvious that the embodiments described are only a part not all the embodiments of the invention. Based on the embodiments of the invention, other embodiments envisaged by the person skilled in the art without the exercise of inventive faculty are all within the protective scope of the invention.

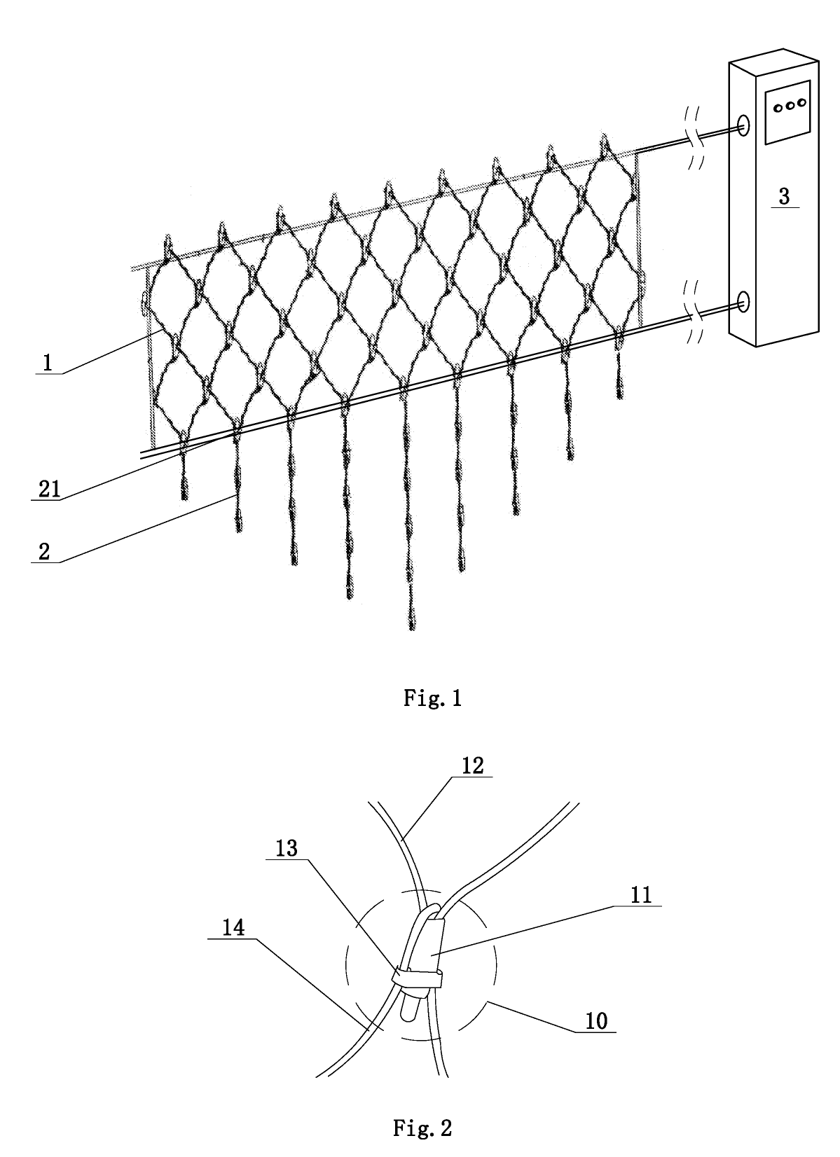

With reference to the FIG. 1, a preferred embodiment of the invention is shown. The decorative light string includes a net lamp 1 and an ice bar lamp 2. The net lamp 1 includes two or more light strings in side-by-side arrangement, which are interdigitated with each other and are woven into a mesh net lamp 1. The ice bar lamp 2 includes a main lamp line 21 which is arranged parallel to the light strings, and strip lamps which are hung at intervals on the main lamp line 21, and the main lamp line 21 of the ice bar lamp 2 is woven at the bottom of the net lamp. The light strings forming the net lamp 1 and the ice bar lamp 2 are respectively connected to a control box 3, and the control box 3 controls the light strings forming the net lamp 1 and the ice bar lamp 2 to flicker and twinkle in a hierarchical manner in up and down directions. According to the invention, when the net lamp 1 is woven by using the light strings, the ice bar lamp 2 is woven at the bottom of the net lamp at the same time, so that the decorative light string has the characteristics of the net lamp 1 and the ice bar lamp 2 at the same time so as to obtain a novel and characteristic decorative effect; and the decorative light string disclosed by the invention can be either suspended below the eave or at the upper end of the window or put on grass or the tree. The net lamp 1 and the ice bar lamp 2 are controlled to twinkle in a layered manner by the control box 3, so that the user will experience a new impression.

The weaving method of the net lamp 1 is described with reference to the FIG. 2. The net lamp 1 includes a plurality of light strings in horizontally side-by-side arrangement. A lampholder 11 and a wire 12 connected to the lampholder 11 in the same light string form a slipknot 10, and another wire 14 from a lower light string passes through the slipknot 10 from the rear part of a lampholder (e.g. the lampholder 11) of an adjacent upper light string to be woven; the wire 14 of the lower light string passing through the lampholder (e.g. the lampholder 11) of the upper adjacent light string are fixed by a positioning buckle 13 provided around two sides of the lampholder. In particular, the positioning buckle 13 is separate from the lampholder and is tied around the lampholder to sandwich the wires 12, 13 to the lampholder. The woven structure is applied to each lampholder on the light strings, and the finished woven structure is tensioned to form the net lamp 1 of a grid shape.

Further, the lengths of the hanging strip lamps are set according to required styles of the ice bar lamps 2 including consistent length, gradual change in length or alternative arrangement of long and short strip lamps, and irregular arrangement, so as to obtain various decorative effects.

The above specific structure and size are specific description of the preferred embodiment of the invention. But the invention is not limited by the embodiments. Those skilled in the art also can make various equivalent variations or substitutions without departing from the spirit of the invention. These variations or substitutions shall all be included within the scope defined by the claims of the application.

1. A decorative light, comprising:
a net lamp including two or more light strings in side-by-side arrangement, each light string including a series of spaced apart lampholders along a line connected by a wire, the light strings are interdigitated with each other and woven into a mesh; and
an ice bar lamp woven at a bottom of the mesh, the ice bar lamp including a main line and a plurality of strip lamps connected at spaced apart portions of the main line.

2. The decorative light according to claim 1, wherein each wire between two adjacent lampholders of a lower light string is fixed to a lampholder of an adjacent upper light string so that the mesh is formed.

3. The decorative light according to claim 2, wherein the net lamp is provided with a plurality of positioning buckles around each lampholder, and the cable of the lower light string is fixed by the respective positioning buckles to the respective lampholders of the upper light string.

4. The decorative light according to claim 1, wherein the ice bar lamp comprises a main lamp line arranged parallel to the light strings and strip lamps connected to the main lamp line and hung at intervals below the main lamp line.

5. The decorative light according to claim 4, wherein the main lamp line of the ice bar lamp is woven to a bottom light string of the net lamp.

6. The decorative light according to claim 4, wherein lengths of the strip lamps hung at intervals below the main lamp line are arranged to form a required style of the ice bar lamp.

7. The decorative light according to claim 1, wherein the light strings forming the net lamp and the ice bar lamp are respectively connected to a control box, and the control box controls the light strings forming the net lamp and the ice bar lamp to flicker and twinkle in a hierarchical manner in up and down directions.
